(19) United States
(12) Patent Application Publication
(10) Pub. No.: US 2010/0295288 A1
(43) Pub. Date: Nov. 25, 2010

(54) PRINTED IDENTIFICATION DOCUMENT AND PROCESS FOR PRINTING SUCH A DOCUMENT

(75) Inventors: Francoise Chabut, Meudon (FR); Denis Vere, Meudon (FR); Christophe Martinat, Meudon (FR)

Correspondence Address: THE JANSSON FIRM, 3616 Far West Blvd, Ste 117-314, AUSTIN, TX, 78731, US

(73) Assignee: GEMALTO SA, Meudon (FR)

(21) Appl. No.: 12/525,547

(22) PCT Filed: Jan. 23, 2008
(86) PCT No.: PCT/IB08/00231

§ 371 Date: Jun. 9, 2010

(30) Foreign Application Priority Data
Feb. 19, 2007 (EP) 07290218.2

(51) Int. Cl. B42D 15/00; B41J 25/304

(52) U.S. Cl. 283/75; 347/197

(57) ABSTRACT

The invention concerns the personalisation graphics of identification documents. The identification document comprises a body where at least one of the main surfaces forms a print surface, on which artwork (14A, 14B) and/or personalised information (24A, 24B) are printed, the said print surface being covered with reinforced protective film (31A, 31B). The identification document further comprises a protective overlay (25A, 25B) transferred to the print surface with an ink ribbon, the said protective overlay being capable of enabling the adherence of the said reinforced protective film (31A, 31B) on the ink transferred to the said print surface.

This invention concerns the personalisation graphics of identification documents.

The invention falls within the field of the printing of identification documents and is particularly aimed at enhancing the security of identification information printed on the surface of such documents.

More particularly, the invention can find an application in identification documents that are linked with security application, such as, for instance, identity cards, secure access cards, driving licences, health cards, credit cards, passports etc. These documents may or may not include IC modules that require contact or otherwise, depending on the use for which they are designed. The personalised information includes the personal data of the holder of the card, such as their photograph, name, date of birth, social security number, biometric information such as fingerprints for instance, date of validity, the identification number allocated to the document etc.

The personalised information is generally printed on top of a background, either by the manufacturer or by its customer or another party. Personalisation graphics are also called post-personalisation, because the stage consisting in printing the personal information about each holder of a card or identification document is the last stage in the process of manufacturing such a card. Post-personalisation graphics are generally achieved by direct thermal transfer or by thermal sublimation, better known by its acronym D2T2 (Dye Diffusion Thermal Transfer). These two printing techniques use ink ribbons, divided into panels and sensitive to heat. At the time of printing, the panels pass entirely on the document to be printed, and an ink panel can therefore only be used once. For colour printing, four-colour ribbons are generally used.

For instance, the well-known ribbons of the YMCK type may be used, where YMCK respectively designate the yellow, magenta, cyan and black panels respectively on one side of the document to print and the last K designates the black panel on the second side of the document to print. When the document in question is a card, it is indeed advantageous to use a ribbon that allows printing on both sides. Of course, there are ribbons for printing on one side only.

There are also ribbons of the YMCKT KT type, also called YMCKO KO, where T and O stand for topcoat, which is a protective overlay that is 2-μm thick. The protective overlay is applied when the card is printed, by means of thermal transfer.

In the area of multilayer plastic cards, ribbons of the YMCKT KT or YMCKO KO type with a protective overlay are used to print cards designed for applications with a short life, typically one or two years. The protective overlay is damaged over time, because of environmental attacks of the mechanical or physical-chemical type.

The post-personalisation of cards intended for applications with a longer life, such as identity cards, health cards or driving licences, requires the use of ribbons of the YMCK K type and the application of a lamination patch over the entire printed surface. That lamination patch, which is also called a reinforced protective film, is 10 to 25 μm thick and is generally made of PET (polyethylene terephthalate) with applied glue. It is sufficiently rugged to withstand external attacks for several years.

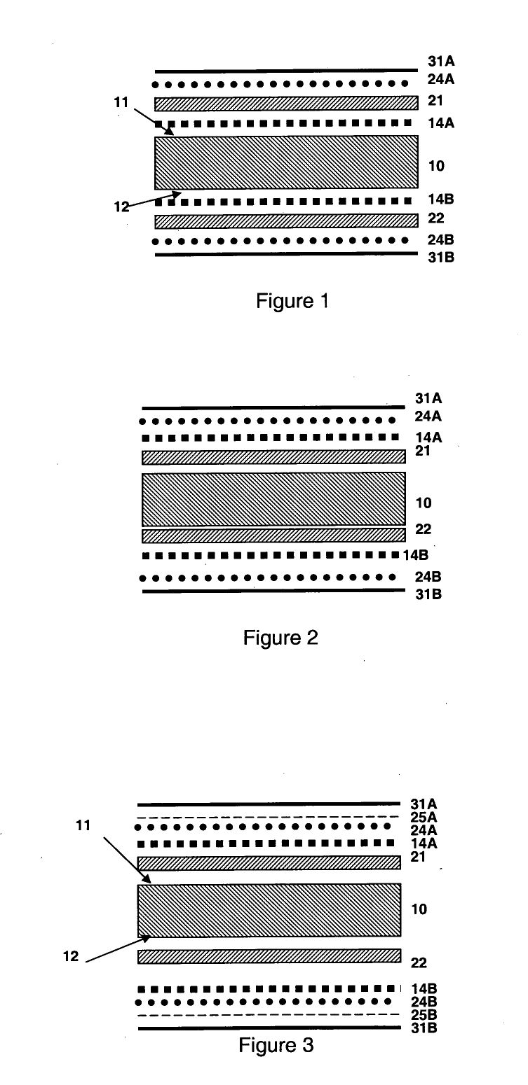

A sectional view of a conventional card body with printing on both sides is shown in FIG. 1. Such a card body generally comprises a plastic core 10 that may be made of several layers laminated to each other. The plastic used to make the core may for instance be polyvinyl chloride (PVC) or polyethylene terephthalate (PET) or polycarbonate (PC). The core may also be made up of several different types of plastic, such as PET/PVC etc. If the card is designed for use at least with contactless applications, the core may comprise electronic components such as at least an IC module and/or a contactless module and/or an antenna or other components. At least one of the main surfaces 11, 12 of core 10 is then printed to apply the background 14A, 14B, better known as artwork. The artwork is in general obtained with the help of offset printing or screen printing. Core 10 printed in this way is then covered on both main sides with protective plastic coats 21, 22, better known as overlays. These overlays are generally made of PVC or PET or PC. The overlays 21, 22 are laminated to the body of the printed card. The personalised information 24A, 24B is then printed on the surface of at least one overlay 21, 22 above the artwork 14A, 14B printed previously. Post-personalisation is carried out by means of a thermal transfer process using a ribbon of the YMCK K type. Reinforced protective film 31A, 31B with glue applied on it is then placed on the post-personalisation. That reinforced protective film is generally made of polyethylene terephthalate and is about 10 to 25-μm thick.

However, the thickness of the overlay 21, 22 creates a gap of about 50 to 100 μm between the artwork 14A, 14B and the personalised information 24A, 24B. As a result, fraudsters can easily remove the post-personalisation data without damaging the artwork on the card because there is high tolerance, generally 50 to 100 μm, before the artwork is reached. The post-personalisation data can be removed by sanding it off or with a solvent such as alcohol for instance.

Thus, when the post-personalisation information is removed, the counterfeiter can reuse the card body and print it with other personalised information. They can also scan the artwork of the card and reproduce fully counterfeit cards.

To solve that problem of fraud, one solution such as that illustrated in FIG. 2 consists in printing the artwork and personalised information on a the same surface of least one of the overlays 21, 22, and then covering them with reinforced protective film 31A, 31B. In that way, the graphics post-personalisation adheres to the ink of the artwork and there is no layer of overlay between the artwork and the personalised information, so that fraudsters can no longer remove the personalised information without damaging the artwork.

Unfortunately, that enhancement of the security of the post-personalisation leads to another problem relating to the life of such cards. The reinforced protective film is no longer in contact with the overlay plastic 21, 22 or directly with the surface 11, 12 of the body of the card, but only with the ink of the artwork and the post-personalisation. Film bonding is thus considerably reduced, if not missing altogether. This problem is not compatible with the security applications of such cards, which need to have long lives.

That is why the technical problem object of this invention is to propose an identification document that comprises a body where at least one of the main surfaces forms a print surface, on which artwork and/or personalised information are printed, which print surface is covered with a reinforced protective film, which would make it possible to make the reinforced protective film bond effectively with the ink printed on the print surface, so as to obtain an identification document with a long life and with printing that is secure from fraud.

The technical problem posed is solved according to this invention by the fact that the identification document additionally includes a protective overlay transferred to the print surface by means of an ink ribbon, the said protective overlay being capable of fixing the reinforced protection film above the ink of the print surface.

It was thus found, as a complete surprise, that the protective overlay of ink ribbons generally used to print cards with a short life can also act as the adhesive to ensure that the reinforced protective film adheres above the ink applied on the print surface. Consequently, the overlays of ink ribbons used until now to print short-life media can now be used for secure printing on long-life media.

The invention also covers a print process for an identification document comprising a body where at least one of the main surfaces forms a print surface on which artwork and/or personalised information are printed. The process is remarkable because of the fact that at least one print stage is carried out by thermal transfer using an ink ribbon with a protective overlay, and the fact that it additionally consists in adding reinforced protective film on the said print surface so that the protective overlay of the ink ribbon makes it possible to fix the said reinforced protective film on the ink transferred to the print surface.

Another object of the invention lies in the use of the protective overlay of a thermal transfer ink ribbon to make an adhesive means between the ink from the ink ribbon transferred to a print surface and a reinforced protective film applied on the said print surface.

In that way, while the first application of the protective overlay of the ink ribbon is to offer protection to the ink from outside attacks, a second application has been discovered entirely by surprise. According to this second application, the protective overlay is used as an adhesive means to fix reinforced protective film on the ink applied to a printed surface.

Other particularities and advantages of the invention will become clearer in the description below, which has been provided as an illustrative and non-limitative example by reference to the enclosed figures that represent:

FIG. 1, already described, is a sectional diagram of the layers that make up a card printed on both sides according to the prior art,

FIG. 2, already described, is a sectional diagram of the layers that make up another card printed on both sides according to another embodiment of the prior art,

FIG. 3 is a sectional diagram of a card printed on both sides according to the invention.

FIG. 3 is a diagram of a card of the identity card type, with or without an IC module, printed on both sides. The card comprises a body 10, obtained by different known processes such as moulding or laminating several layers, and two protective overlays 21, 22 laminated on the main surfaces, 11, 12 of the body 10. The body may be made of different materials such as PVC, PET PC, ABS etc. The overlays are generally transparent and made of PVC, PET or PC. They are 50 to 100 μm thick and their task is offer protection to the surfaces of the card body from outside environmental attacks.

Artwork 14A, 14B is then printed on the surface of at least one of the overlays 21, 22. That artwork is printed with a conventional printing process such as for instance offset or screen printing.

Post-personalisation, which consists in printing personalised information 24A, 24B, is then carried out directly on the artwork or directly on the surface of an overlay when the artwork is only printed on one side and post-personalisation is carried out on both sides. Post-personalisation is achieved by direct thermal transfer or by sublimation with an ink ribbon. For printing on both sides, a multi-colour multi-panel ink ribbon may for example be used. In that way, YMCKT KT ribbon, also called YMCKO KO, may be used to print one side in four colours, e.g. by transferring a colour photograph, for instance, and information about the holder in black ink, and to print the second side in monochrome printing, for instance by transferring a serial number or a bar code in black.

Whatever the process, the ribbon must comprise a protective overlay 25A, 25B, also called a topcoat, and designated by the letters T or O. That protective overlay makes up a transparent finishing coat that is designed, in its habitual use, to protect the ink from mechanical attacks such as scratching. The overlay is about 2 μm thick.

The presence of the overlay 25A, 25B is indeed indispensable for the subsequent adherence of a reinforced protective film 31A, 31B on the ink of the printed surface. Surprisingly, it has been found that the protective overlay can additionally be used as an adhesive means to fix the reinforced protective film on the ink. The reinforced protective film 31A, 31B is 10 to 25 μm thick and offers heightened protection to the printed surface from external environmental attacks, making it possible to make long-life cards. It is generally transferred by means of a low-temperature lamination process.

Thus, it was found completely unexpectedly that the ink ribbons that are conventionally used to print short-life products may be used to print long-life products when the protective overlay is used as an adhesive means to fix the reinforced protective film on the ink.

The protective overlay of the ink ribbon thus offers the benefit of increasing the bonding of the reinforced protective film on the ink and simultaneously increasing the security of the printing.

Also within the context of the invention, the reinforced protective film may have different thicknesses on either side. It may be fully transparent or have security features such as holograms or guilloche patterns etc.

The invention applies to all documents such as cards, badges, passports or visas for example, regardless of the manufacturing process. The invention therefore applies to laminated cards as well as moulded ones, made in sheets or on a card-by-card basis.

Post-personalisation and the depositing of the reinforced protective film may be carried out at the same time, with the same printer, or in two successive stages.

The reinforced protective film may further include an opening when the card comprises a flush-contact module, so that the opening surrounds the perimeter of the connection element of the module.

Besides, the artwork may also be coated with protective varnish that is compatible with the post-personalisation stage. Such varnish may be used to form a barrier that prevents the transfer of the ink from the artwork on the ink ribbon while printing by means of thermal transfer. The varnish is fine and selected so as to allow close subsequent bonding of the post-personalisation ink. The varnish may for instance be varnish selected from heat-activatable varnishes whose chemical properties allow bonding by different interfaces made of polyurethane, polyamide or polyester etc.

Lastly, the protective overlay of the ink ribbon need not be transferred to the whole print surface of the card. That is because the protective overlay only needs to be transferred to a few cleverly selected areas to enable effective fixing of the reinforced protective film on the ink. For instance, the protective overlay of the ink ribbon may be transferred to all the areas of the print surface with the exception of those covered by personalised information. One benefit of that method would be to reduce the manufacturing costs, because the colour panels are divided into two. The ribbon is supplied with yellow, magenta and cyan panels that are half as long as the standard size, whilst the size of the black panels remains unchanged. In this mode of embodiment, the size of the panel of the protective overlay is also half as long as the standard size. In that case, the printer is set to print only half a panel.

If there is no post-personalisation on one of the sides, reinforced protective film may still be fixed to the artwork. In that case, only the protective overlay of the ink ribbon is transferred to the printed surface, before it is covered by the reinforced protective film.

The embodiments that have been described above relate to cards where the print surfaces are made up of protective overlays 21, 22 laminated on the main surfaces 11, 12 of the body of the card. However, the invention also applies to cards with no such protective overlays, where the print surfaces are directly made up by the main surfaces 11, 12 of the body of the card.

1. An identification document with a body where at least one of the main surfaces of the body forms a print surface, on which are printed artwork and/or personalized information, the said print surface being covered with a reinforced protective film, wherein the reinforced protective film comprises a protective overlay transferred on the print surface by means of an ink ribbon, the protective overlay being capable of enabling the adherence of the reinforced protective film on the ink transferred to the print surface.

2. The identification document according to claim 1, wherein the protective overlay covers at least part of the print surface.

3. The identification document according to claim 1 or 2, wherein the identification document further comprises a protective varnish between the artwork and the personalized information.

4. A process for printing an identification document comprising a body where at least one of the main surfaces forms a print surface, on which are printed artwork and/or personalized information, wherein the at least one printing step is achieved by thermal transfer using an ink ribbon including a protective overlay, and the process further comprises adding a reinforced protective film to the said print surface, so that the protective overlay of the ink ribbon enables adherence of the reinforced protective film on the ink transferred to the print surface.

5. A method of producing an identification card using: a protective overlay of a thermal transfer ink ribbon for making adhesive means between the ink from the ink ribbon transferred to a print surface and a reinforced protective film covering the said print surface.
